(19) United States
(12) Patent Application Publication
(10) Pub. No.: US 2012/0152612 A1
(43) Pub. Date: Jun. 21, 2012

(54) FEEDTHROUGH FOR A WALL OF A PACKAGE

(75) Inventors: Claude Drevon, Toulouse (FR); Olivier Vendier, Lacroix-Falgarde (FR); David Nevo, Toulouse (FR)

(73) Assignee: THALES, NEUILLY SUR SEINE (FR)

(21) Appl. No.: 13/393,771

(22) PCT Filed: Sep. 2, 2010
(86) PCT No.: PCT/EP10/62857

§ 371 Date: Mar. 1, 2012

(30) Foreign Application Priority Data
Sep. 4, 2009 (FR) 0904214

(51) Int. Cl. H02G 3/18

(52) U.S. Cl. 174/669

(57) ABSTRACT

A signal transfer device which can be used to transfer a signal through a wall of a power package including a base, the wall bounding an internal part and an external part, said device including a first signal line portion outside the package; a second signal line portion inside the package; and a third signal line portion connecting the other two portions, wherein the first portion is shifted from the wall so as to respect a predefined safety distance; and the third portion is buried over its entire length.

The invention relates to the field of power packages and more particularly to feedthroughs provided in these packages.

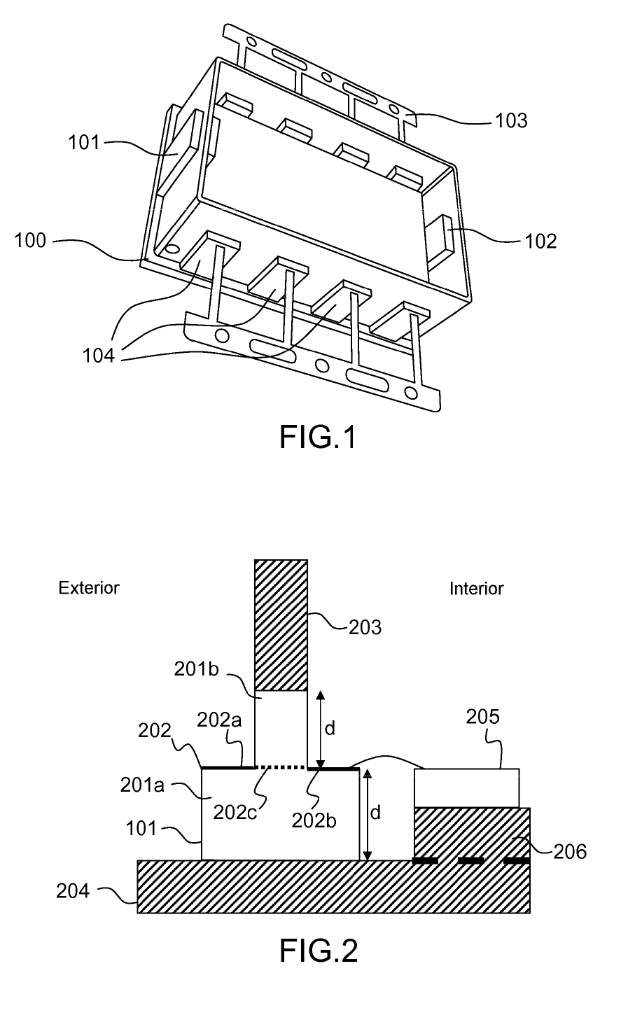

FIG. 1 shows a hermetic power package.

Such a package comprises a metal base 100 on which a metal partition comprising four walls is placed. Two hermetic feedthroughs 101 and 102, each located in an opposed wall, allow a mainly microwave signal line (not shown) to enter and exit.

Hermetic feedthroughs 104 allow low-frequency signals, such as supply or control signals, to be delivered. A metal grid 103 allows these various signals to be connected together, during the phase of assembling the various components, in order to prevent electrostatic discharges.

This type of micropackage is used in the microwave field to provide electronic functions based on bare chips such as high-power amplifiers.

FIG. 2 shows a cross section through a hermetic feedthrough of the prior art. The feedthrough 101, made of a ceramic insulator, allows a signal line 202 to pass through a wall 203 of a package. The feedthrough rests on the base 204 of the package. The signal line comprises a first part 202a outside the package, a second part 202b inside the package and a third part 202c embedded in the feedthrough. The signal line is connected to components 205 located inside the package. A pedestal 206 placed between the base 204 and the components 205 allows the components to be placed at the same level as the signal line 202 and to limit any microwave mismatch due to the length of the connecting wire.

The multilayer ceramic feedthrough comprises: a first layer 201a in contact with the base 204 of the package, on the surface of which layer a signal line 202 is placed; and a second layer 201b covering the first layer 201a at the wall 203.

One of the main problems of using vacuum power packages is the existence of an effect called multipacting that may arise near hermetic feedthroughs. Multipacting is a parasitic effect that occurs in devices that transmit microwaves under vacuum. It is in particular found in vacuum tubes, particle accelerators and microwave circuits on board satellites. The basic multipacting mechanism is the following: primary electrons, accelerated by the microwave field, bombard a surface causing the emission of secondary electrons that are in turn accelerated by the microwave field and bombard a surface causing the emission of other secondary electrons. For a given geometry and for certain frequencies and amplitudes of the field, the conditions for exponential growth in the number of electrons in transit are met. The conditions for multipacting discharge are then satisfied. The growth in the number of electrons in transit is limited by a saturation effect, and the discharge may fluctuate over time.

Multipacting is most often an unwanted effect: the microwave field loses energy for accelerating the electrons and the energy thus acquired by the electrons is essentially converted into heat on impact (the energy of the secondary electrons emitted is low). There is thus both a reduction in the energy transmitted or stored in the microwave structure and heating of the latter.

This discharge effect occurs in packages between the part of the signal line outside the package, on the one hand, and the metal casing of the package, on the other. It consequently destroys the signal line. The part of the signal line inside hermetic packages is not affected because the package then contains a gas. In the case of nonhermetic packages, the part of the signal line inside the package is also affected by multipacting. The simplest way to prevent this effect consists in sufficiently distancing the external signal line from other conductive elements. To do this, a minimum safety distance d is calculated that allows multipacting to be avoided. This distance depends on the power of the signal. Typically for a 40 W signal, the safety distance is 2 mm for a 6 dB margin and 2.5 mm for a 10 dB margin. The margin allows for uncertainty in the electromagnetic simulations and in the manufacturing tolerances to be overcome. According to standards in force, a 6 dB margin is considered to be sufficient to guarantee the complete absence of multipacting, but an electrical test is necessary to confirm the absence thereof. A 10 dB margin is sufficient to dispense with the electrical test.

The height of the first layer 201a of the feedthrough is therefore at least equal to this safety distance d so as to prevent multipacting between the line 202 and the base 204 of the package. The height of the second layer 201b is at least equal to the safety distance d so as to prevent multipacting between the line 202 and the wall 203 of the package. The height of the feedthrough is therefore at least twice the safety distance d. Typically, for a transmitted power of 40 W, the feedthrough has a total height of 5 mm for a 10 dB margin. This distance d is also applicable in the horizontal plane between the line 202a and the metal wall.

A problem arises when it is desired to transmit more power in the lines. For example, for a power of 150 W the safety distance d becomes 5 mm with a 10 dB margin. This distance implies increasing the height of the hermetic feedthroughs. According to the prior art, a manufacturing limit is reached with a ceramic feedthrough height of about 6 mm. In other words, it is very difficult to manufacture a feedthrough 10 mm in height.

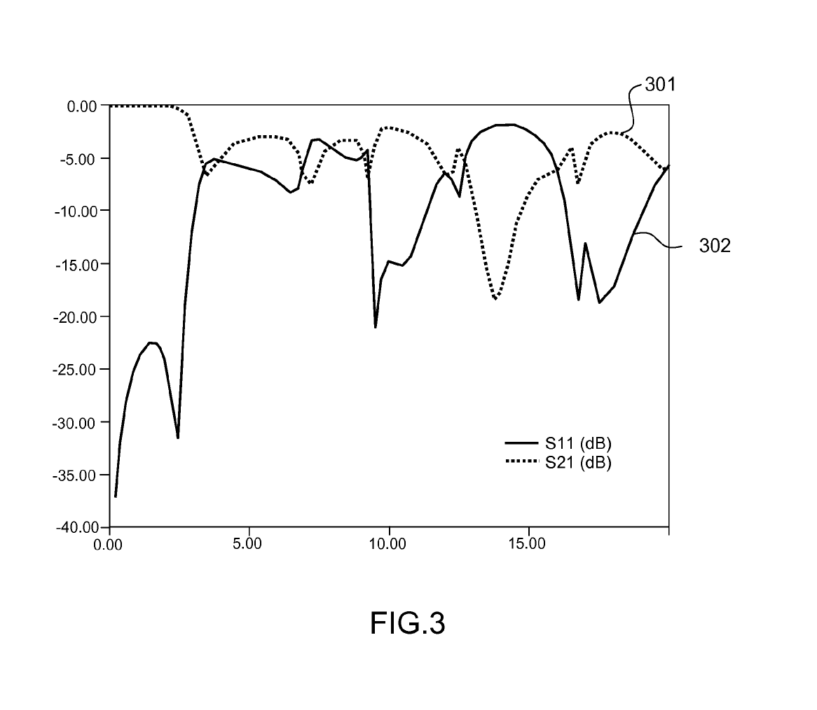

In addition, increasing the height of the substrate in which the feedthrough is produced causes electrical problems that are difficult to solve. FIG. 3 shows a curve 302 of the variation in the reflection coefficient of a signal at the input/output of a 10 mm-tall feedthrough and an associated power loss curve 301. The Y-axis unit is decibels and the X-axis unit is gigahertz. On plotting the response curve, a cutoff frequency is observed below which the power loss of the transmitted signal is negligible and above which the power loss increases abruptly. Above this frequency the feedthrough can no longer be used. This effect is due to the fact that the wave no longer propagates in the signal line, the signal line beginning to radiate like an antenna. For a feedthrough 10 mm in height, the cutoff frequency is located at about 2 GHz. The feedthrough cannot therefore be used with a 3 GHz signal.

In summary, such a feedthrough has the following drawbacks: firstly, this feedthrough is very difficult to manufacture; in addition it has an electrical limitation (for frequencies above 2 GHz); and finally the total height of the pedestal-free package is unacceptable and incompatible with known manufacturing means.

Another solution consists in covering the grounded metal parts (walls of the package and base) with insulating paint. However, there is a risk of peeling. In addition, it is difficult to apply this paint.

Another alternative is to cover the external signal line with a resin (glob-top). However, there is a risk of cracking, of peeling under temperature cycles and of modification of the electrical response due to the presence of a resin on the line 202a, this resin having a significant dielectric constant.

The invention aims to alleviate the aforementioned problems by providing a feedthrough that minimizes the risk of multipacting and that operates at high powers.

For this purpose, the subject of the invention is a device for transferring a signal, also called a feedthrough, which can be used to transfer a signal through a wall of a power package comprising a base, by being placed on the base in contact with the wall, the wall bounding an internal part and an external part, said hermetic device comprising a first signal line portion outside the package, a second signal line portion inside the package and a third signal line portion connecting the other two portions, said feedthrough being characterized in that the first portion is shifted from the wall so as to respect a first predefined safety distance and in that the third portion is buried in the device over its entire length.

Using the invention means that it is not necessary to increase the height of the feedthrough to pass more power and thus signal lines matched to 50 ohms can be of smaller width. Therefore the feedthrough and the signal lines associated with it respond better to the highest frequencies.

According to a first embodiment of the invention, the first and second signal line portions are shifted in height, said height being considered parallel to the wall.

One advantage of the first embodiment of the invention is due to its asymmetric aspect. The height of the first layer may be smaller than the safety distance. Thus the height of the signal line inside the package is reduced. It is therefore possible to lower or even remove the pedestal inside the package.

The invention allows ceramic feedthroughs of smaller height to be used. This also limits the height of the partition in which the feedthrough is placed. The aspect ratio of the package (ratio of the width and length, on the one hand, to the height of the metal partition, on the other) is therefore reduced. This leads to less stress (in particular thermomechanical stress) both during manufacture of the package (high-temperature welding of the base 100, of the metal partition 203 and of the feedthroughs 101, 102 and 104) and after hermetic sealing of the package.

The invention will be better understood and other advantages will become clear on reading the detailed description given by way of nonlimiting example and with the aid of the figures, among which:

FIG. 1, presented above, shows a hermetic power package;

FIG. 2, presented above, shows a cross-sectional view of a hermetic feedthrough according to the prior art;

FIG. 3, presented above, shows a response curve of a known prior-art feedthrough;

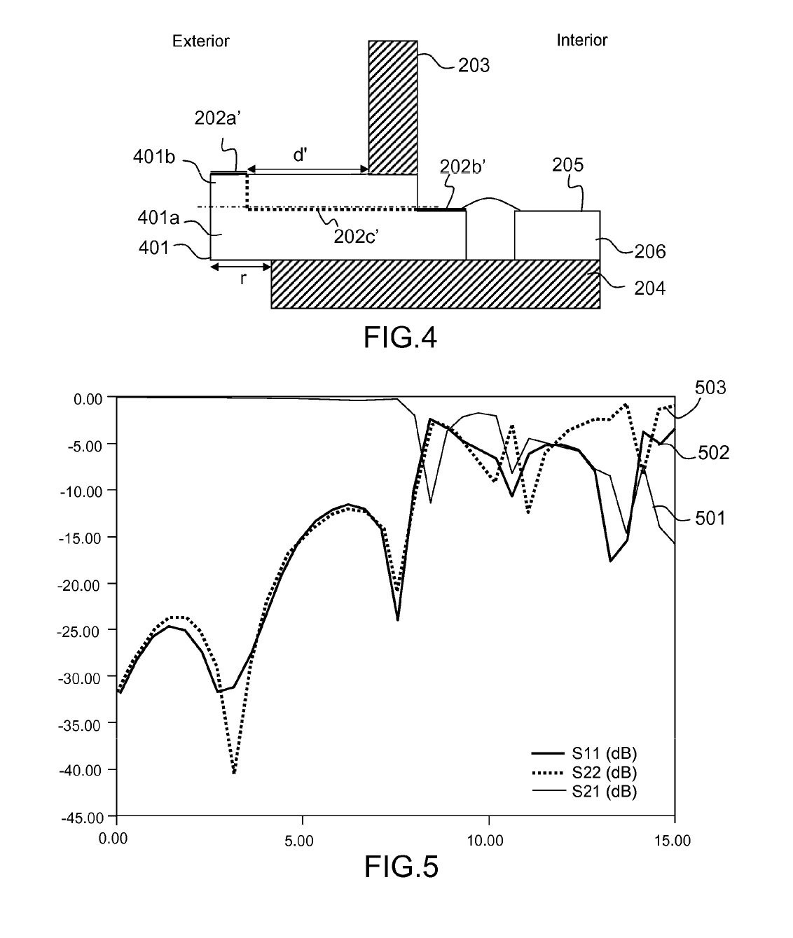

FIG. 4 shows a cross-sectional view of a first embodiment of a feedthrough according to the invention;

FIG. 5 shows a response curve of a feedthrough according to the invention; and

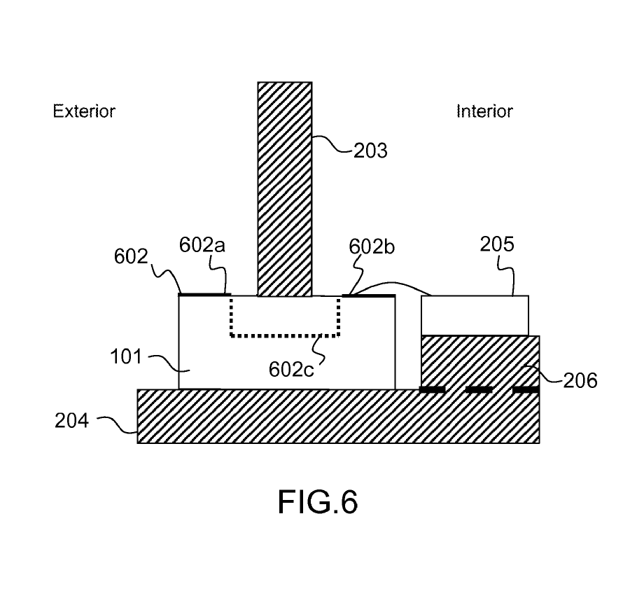

FIG. 6 shows a cross-sectional view of a second embodiment of a feedthrough according to the invention.

FIG. 4 shows a cross-sectional view of a first embodiment of a feedthrough according to the invention. The feedthrough of a wall 203 of a power package allows a signal line to pass. The package comprises a base 204. The wall 203 bounds an internal part and an external part. The feedthrough comprises a first signal line portion 202a′ outside the package, a second signal line portion 202b′ inside the package and a third signal line portion 202c′ connecting the two other portions 202a′, 202b′. The first portion 202a′ is shifted from the wall so as to respect a first predefined safety distance from the wall. The third portion 202c′ is buried over its entire length.

The third signal line portion 202c′ is shifted in height relative to the first signal line portion 202a′.

The first safety distance aims to prevent multipacting outside the package.

In practice, the multilayer feedthrough comprises a first layer 401a in contact with the base 204 of the package. The first layer is a parallelepipedal block. The third signal line portion 202c′ is placed on the surface of the first layer 401a.

The feedthrough comprises a second layer 401b covering the first layer 401a in the part outside the package and in the wall 203 of the package. The second layer is a parallelepipedal block through the volume of which a plated hole passes. This plated hole connects the third portion 202c′ of the signal line (located in contact with the lower face of the second layer) to the first signal line portion 202a′ located on the upper face of the second layer 401b.

According to the first embodiment of the invention, the first 202a′ and second 202b′ signal line portions are shifted in height, said height being considered parallel to the wall 203. By employing this embodiment of the invention, it is possible to reduce the height of the first layer and therefore to lower or even remove the pedestal 206 supporting the components 205 to which the signal line is connected.

The first signal line portion 202a′ is sufficiently far away that the predefined safety distance is respected. For example, for a safety distance d′ of 5 mm from the wall, the first signal line portion 202a′ is shifted by a distance of 5 mm.

Outside the package, the first signal line portion 202a′ is placed on the second layer 401b. A plated hole produced in this second layer 401b allows the signal to be delivered to the interface between the layers 401b and 401a. The buried third portion 202c′ lies on the surface of the layer 401a. The second signal line portion 202b′ can be accessed from the internal part in order to be connected to the associated component.

The various lines are produced by screen-printing conductive pastes. A nickel/gold finish is applied to the external signal line parts 202a′ and 202c′.

The third portion 202c′ of the signal line is buried. Since multipacting only occurs in vacuum, this line portion cannot therefore be affected. The safety distance d to be considered is the distance between the first signal line portion 202a′ on the surface of the second layer and the metal parts of the package, i.e. the wall on the one hand and the base on the other.

The signal line 202c′ is buried in the feedthrough outside the package. This allows the line to be distanced, in vacuum, from a ground plane without increasing the height of the feedthrough.

One of the advantages of the invention is that it performs better when used with high-frequency signals. FIG. 5 shows the response curve of a feedthrough according to the invention. Curve 501 shows power loss between the input and output of the feedthrough. Curves 502 and 503 correspond to reflection parameters at the input and output, respectively. The feedthrough is 4 mm in height and the signal power is 150 W. As for FIG. 3, the curves in FIG. 5 are expressed in decibels as a function of frequency. It will be observed that the sharp power loss does not occur at 2 GHz as was the case for the known prior-art feedthrough but at about 7.5 GHz.

According to a second embodiment of the invention, the second signal line portion 202b′ is shifted from the wall so as to respect a second predefined safety distance. FIG. 6 shows a cross-sectional view of a second embodiment of a hermetic feedthrough according to the invention. As for the first embodiment, the hermetic feedthrough comprises a first signal line portion 602a outside the package, a second signal line portion 602b inside the package and a third signal line portion 602c connecting the two other portions 602a, 602b. The first portion 602a is shifted from the wall so as to respect a first predefined safety distance from the wall. The third portion 602c is buried over its entire length. Nevertheless, as the first portion 602a and the second portion 602b are not shifted in height, it may then be necessary to use a pedestal 206 inside the package.

In the case where the package is a hermetic package, the second safety distance is intended to prevent corona forming inside the package.

Corona appears when the internal pressure of the package used in orbit drops on account of the leakage from the package that occurs at the rate determined on the ground. There is no standard way of preventing corona from forming except by distancing the signal line from any ground plane, in order to reduce the electric field that induces the discharge, or by burying the conductors in a protective dielectric, so that the plasma forms only at very high levels. Corona is a type of discharge produced when a current, whether DC or not, flows between two electrodes raised to a high potential and separated by a neutral fluid, in general air, by ionization of this fluid. A plasma is then created and electrical charge is transported by transferring from ions to neutral gas molecules. When the electric field at a point in the fluid is sufficiently high, the fluid ionizes about this point and becomes conductive. If the geometry of the conductor and the field value are such that the ionized region expands rather than stabilizing, the current can finish by finding a path as far as the opposite electrode, sparks or an electric arc then forming that destroy the structure.

In the case where the package is a nonhermetic package, the second safety distance is intended to prevent multipacting inside the package. If the package is no longer hermetic, the interior of the package is also under vacuum. Under these conditions, the signal line may also be subjected to multipacting. In this case the feedthrough will be symmetric.

According to one variant of the invention, the feedthrough is made of a hermetic insulating material (and obtained by high-temperature sintering) such as, for example, ceramics mainly composed of alumina powder, binders, plasticizers and other additives. The hermetic insulating material may be used both in hermetic packages and in nonhermetic packages.

According to another variant of the invention, the feedthrough is made of an organic material. This type of material may for example be based on a glass-fiber-reinforced or quartz-fiber-reinforced epoxy resin. Making the feedthrough from an organic material makes the final package nonhermetic by nature.

Advantageously, the feedthrough is placed on the base so as to form a recess r relative to the base. This has the effect of increasing the distance between the base and the external part of the signal line. It is thus possible to use a first layer that is smaller in height than the first safety distance. This may make it possible to remove the pedestal from inside the package. The length of the recess r is for example 1 mm. The heights of the first and second layers 401a and 401b are then 1 mm and 3 mm, respectively.

Advantageously, the feedthrough furthermore comprises a resin covering the first signal line portion 202a′. The resin is placed on the connecting region 202a′ and the associated connecting wire. The resin is by nature insulating, thereby increasing the distance d between the metal body of the package and the live microwave line.

Advantageously, the feedthrough furthermore comprises a resin covering the second signal line portion 202b′.

1. A signal transfer device, which can be used to transfer a signal through a wall of a power package comprising a base, by being placed on the base in contact with the wall, the wall bounding an internal part and an external part, said device comprising;
a first signal line portion outside the package;
a second signal line portion inside the package, and
a third signal line portion connecting the other two portions, wherein
the first portion is shifted from the wall so as to respect a first predefined safety distance; and
the third portion is buried in the device over its entire length.

2. The signal-transfer device according to claim 1, wherein the first and second signal line portions are shifted in height, said height being considered parallel to the wall.

3. The signal-transfer device according to claim 1, wherein the second signal line portion is shifted from the wall so as to respect a second predefined safety distance.

4. The signal-transfer device according to claim 3, wherein the package is hermetic and the second safety distance prevents corona forming inside the package.

5. The signal-transfer device according to claim 3, wherein the package is not hermetic and the second safety distance prevents multipacting inside the package.

6. The signal-transfer device according to claim 4, further comprising a hermetic insulating material obtained by high-temperature sintering.

7. The signal-transfer device according to claim 5, further comprising an organic material.

8. The signal-transfer device as claimed in any one of the preceding claims according to claim 6, wherein the feedthrough is placed on the base so as to form a recess relative to the base.

9. The signal-transfer device according to claim 8, further comprising a resin covering the first signal line portion.

10. The signal-transfer device according to claim 9, further comprising a resin covering the second signal line portion.

11. The signal-transfer device according to claim 5, further comprising a hermetic insulating material obtained by high-temperature sintering.

12. The signal-transfer device according to claim 11, wherein the feedthrough is placed on the base so as to form a recess relative to the base.

13. The signal-transfer device according to claim 12, further comprising a resin covering the first signal line portion.

14. The signal-transfer device according to claim 13, further comprising a resin covering the second signal line portion.

15. The signal-transfer device according to claim 7, wherein the feedthrough is placed on the base so as to form a recess relative to the base.

16. The signal-transfer device according to claim 15, further comprising a resin covering the first signal line portion.

17. The signal-transfer device according to claim 16, further comprising a resin covering the second signal line portion.
